(19) United States
(12) Patent Application Publication
(10) Pub. No.: US 2005/0058782 A1
(43) Pub. Date: Mar. 17, 2005

(54) Decorative article and methods of making the same

(76) Inventor: David T. Ou-Yang, Woodbury, MN (US)

Correspondence Address: Thomas J. Durling;DRINKER BIDDLE & REATH LLP, One Logan Square, 18th & Cherry Streets, Philadelphia, PA, 19103-6996, US

(21) Appl. No.: 10/660,095

(22) Filed: Sep. 11, 2003

(51) Int. Cl. D04D 7/06; D04D 7/10; B32B 3/00

(52) U.S. Cl. 428/4; 428/195.1; 428/209; 428/5; 428/483

(57) ABSTRACT

A decorative bow is provided having a plurality of loops of film. Each of the loops has an inner surface and an outer surface. The film has a transparent polymeric layer, a coating layer, a high refractive index layer and a colorant layer. The coating layer is disposed on a first surface of the polymeric layer. A plurality of embossed images are disposed within the coating layer. The high refractive index layer substantially covers the embossed images. The colorant layer forms the inner surface of the film bow loops upon final construction of the decorative bow and is disposed on either the polymeric layer or the high refractive index layer.

### FIELD OF THE INVENTION

The invention relates to the field of decorative articles, and particularly to decorative bows and ribbons formed from polymer films.

### BACKGROUND OF THE INVENTION

Various polymeric films are known. Some films include special features to provide decorative effects. Certain films include a transparent polymeric layer that is coated with a layer of material that facilitates micro-embossing various designs into the film. This technique enables the manufacture of films with holographic features. Another layer of material, such as zinc sulfide, is sometimes applied over the embossed layer to protect the embossed coating and further enhance the appearance of the film.

However, it is not typical to form a decorative bow from a transparent polymeric film as described, because when a transparent polymeric film is used it is often difficult for the human eye to observe the embossed effects. Therefore, a need exists for a decorative film that enhances the viewability of the embossed features that can be used for making a decorative bow.

### SUMMARY OF THE INVENTION

The invention relates to a clear polymeric film with a micro-embossed coating. A plurality of micro-embossed images is disposed within the coating layer. A high refractive index layer is applied over the micro-embossed coating. A layer of colorant, e.g., ink, is printed on either the clear polymeric layer or the high refractive index layer to increase the viewability of holographic features. The ink layer reflects light incident to the film. This reflection enhances the distinctiveness of the embossed features of the film, particularly when viewed from the uncoated side.

The film is formed into a decorative article having a plurality of loops. The loops have an inner surface and an outer surface. The colorant layer forms the inner surface of the loops.

In another aspect, the invention is directed to a method of making a decorative bow. The method includes the steps of providing a film and applying a colorant thereto. The film has a transparent polymeric layer, a coating layer disposed on a first surface of the transparent layer having a plurality of embossed images therein, and a high refractive index layer substantially covering the embossed images. The colorant is applied to either the polymeric layer or to the high refractive index layer. The method also includes the step of forming a plurality of loops of the film. The loops have an inner surface and an outer surface. The loops are formed such that the inner surface is the colorant layer of the film.

### BRIEF DESCRIPTION OF THE DRAWINGS

For the purpose of illustrating the invention, there are shown in the drawings forms which are presently preferred; it being understood, that this invention is not limited to the precise arrangements and instrumentalities shown.

FIG. 1 is a prior art decorative bow.

FIG. 2A is a schematic cross-section of an embodiment of a film used to construct a decorative article according to the principles of the invention.

FIG. 2B is a schematic cross-section of a second embodiment of a film used to construct a decorative article according to the principles of the invention.

FIG. 3A is a front view of the film of FIG. 2A.

FIG. 3B is a rear view of the film of FIG. 2A.

FIG. 4A is a decorative bow constructed with the film of FIG. 2A according to the principles of the invention.

FIG. 4B is a decorative bow formed from a curled ribbon constructed with the film of FIG. 2A according to the principles of the present invention.

FIG. 5 is a flow-chart describing the steps of making the bow of FIG. 4.

FIGS. 6-12 are color measurements of both the printed side and the non-printed side of various films used to construct a bow of FIG. 4.

FIGS. 13-18 are color measurements of both the printed side and the non-printed side of various films used to construct a bow of FIG. 4.

### DETAILED DESCRIPTION OF THE PREFERRED EMBODIMENTS

In the drawings, in which like numerals indicate like elements, there is shown a decorative bow constructed according to the principles of the invention, a film used to construct the bow, a flow-chart describing a method of making the bow, and color measurements of various colored films that can be used to construct a bow according to the principles of the present invention.

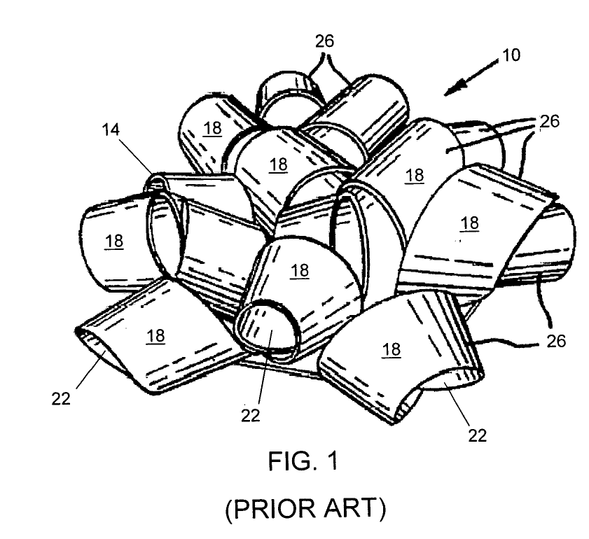

With reference to FIG. 1, a typical decorative bow 10 is constructed of a film 14. The bow includes a plurality of bow loops 18. Each loop has an inner surface 22 and an outer surface 26.

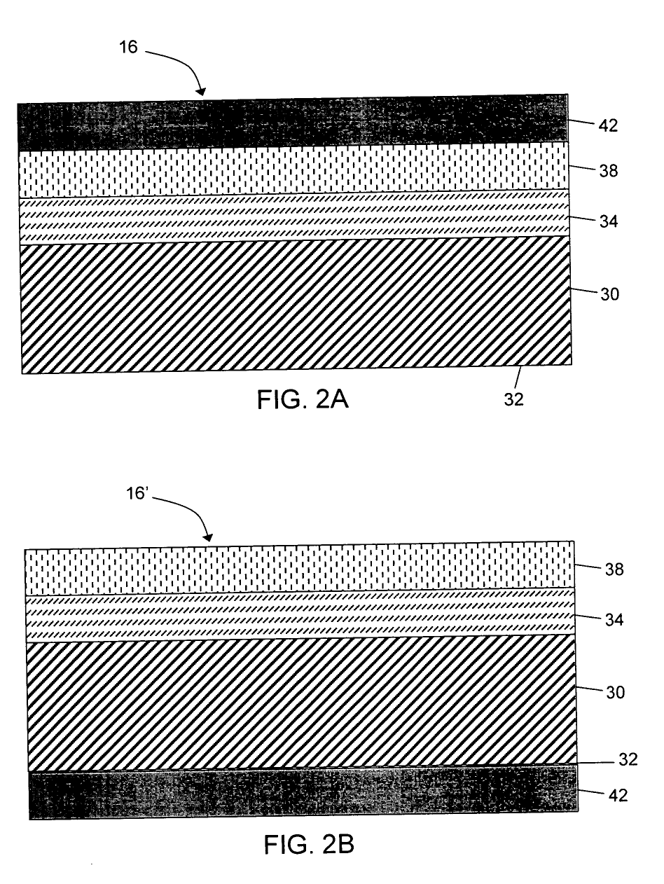

With reference to FIGS. 2A and 2B, a decorative article of the present invention is constructed of a film 16. The film includes a transparent (i.e., clear) polymeric layer 30, a coating layer 34, a high refractive index layer 38 and a colorant layer 42. In a preferred embodiment, the polymeric layer 30 is a transparent polyester (PET), although other polymeric materials can also be used. For example, the polymeric layer 30 can be a biaxially-oriented polypropylene (BOPP) or a polyvinyl chloride (PVC), etc. The transparency of the polymeric layer 30 is a factor to consider when selecting a material.

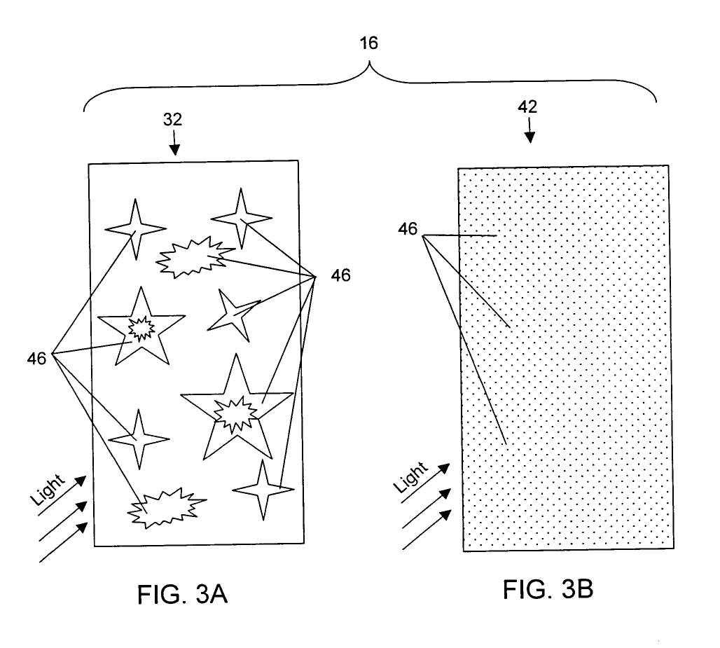

The coating layer 34 is disposed on a first surface (e.g., the top surface) of the polymeric layer 30. The coating layer can be acrylic. However, any coating that is suitable for use with a micro-embossing process can be used. It is desirable that the coating layer be transparent so as not to affect the transparent properties of the polymeric layer 30. The coating layer is embossed with images that are arranged in a particular pattern or design. For example, the coating layer 34 can be micro-embossed with a holographic star pattern (see FIG. 3A), a bubbled pattern, square pattern, etc.

The high refractive index layer 38 is applied to the embossed coating layer 34 to protect the embossed images and to further enhance the visual appearance of the film. The high refractive index layer 38 can be applied using conventional deposition techniques, such as heat evaporation, sputtering, chemical plasma deposition, etc. The high refractive index layer 38 can be zinc sulfide (ZnS) having a refractive index of at least 2.4 at a wavelength of approximately 10.6 82 m. Alternatively, other materials can be used for the high refractive index layer. The transparency of the material is to be considered when selecting a material for the high refractive index layer 38.

In a preferred embodiment, a layer of colorant 42 is disposed on the high refractive index layer 38 (see FIG. 2A). The colorant layer 42 provides protection for the high refractive index layer 38 and increases the viewability of the embossed images. In another embodiment, the film 16′ has the layer of colorant 42 disposed on a second surface 32 (i.e., the bottom surface) of the polymeric layer 30 (see FIG. 2B). The colorant layer 42 can be printed or coated by using any conventional process such as flexographic, gravure, letter press, screen, digital printing and the like. Alternatively, the colorant layer 42 can be coated by low temperature hot melt coating or low temperature extrusion. The colorant layer 42 can also be flood printed, strip printed, or printed with specific patterns. It is desirable to deposit the colorant layer 42 in a continuous and substantially uniform manner.

The colorant layer 42 is selected based on several criteria. In one embodiment, the colorant is transparent ink having a coloring agent, a carrier and a binder. All three components are selected so that the index of refraction of each component closely matches the others. Good results are obtained when the respective indices of refraction of the coloring agent, carrier and binder are within 0.02 of one another. Particle size of the coloring agent is another criterion. Coloring agent having a particle size of less than 7 microns is well suited to achieve the desired effect. Preferably, coloring agent particle size is less than 0.7 micron. Presently, organic pigments are preferred for their resistance to water and ultraviolet light. By way of example, the pigment can be barium lithol, calcium lithol or the like. Examples of appropriate binders are acrylic resin, gum resins or blends thereof. The carrier can be water or solvent. A preferred transparent ink is water based Flink ink 1015 produced by Flink Ink Corporation, Ann Arbor, Mich. It has a viscosity of 15 to 18 seconds measured by a number three Zahn Cup viscometer. The pH value of the ink is about 9.0 to 9.4.

In another embodiment, the film is printed with a metallic ink. Suitable metallic inks include a colorant, a binder, a carrier and metal flakes. The colorant, binder and carrier can be selected as described above in connection with the transparent ink. The metal flakes can be any metal suitable for imparting a metallic appearance to the film, such as copper for a gold-like color, or aluminum for a silver-like color. Although dependent on the metal chosen, it has been found that inks with a metal content of between 10 and 40 percent by weight produce suitable products. One suitable ink is Flink metallic ink 8643, available from Flink Ink Corporation.

In another embodiment, the film is printed with a high gloss opaque ink. Suitable inks have a smooth surface to provide high reflectivity and high gloss. To provide the required properties of high gloss and high opacity, high refractive index additives can be added to the ink. For example, 15-25 percent by weight of titanium oxide or clay can be added.

FIG. 3A depicts the film 16 with light incident to the second surface 32 (i.e., the bottom) of the polymeric layer 30. As a result, a plurality of holographic images 46 is displayed to the human eye when viewing the bottom surface 32 of the polymeric layer 30 of the film 16. The incident light is received by the polymeric layer 30, travels through the coating layer 34 and the transparent high refractive index layer 38. A portion of the incident light is reflected by the colorant layer 42. The reflected portion of the light enhances the viewing of the holographic images 46 to thereby produce a colorful and lively display. Also, the colorant layer 42 absorbs a portion of the incident light, which produces the color of the film.

As shown in FIG. 3B, having the light incident to the colorant layer 42 reduces the sharpness and liveliness of the holographic images 46. In such an environment, light that is not initially reflected or absorbed by the colorant layer 42 travels through the remaining layers of the film 16. A portion of the light reflected by the polymeric layer 30 and absorbed by the colorant layer 42, which reduces the aesthetic properties of the holographic images 46. In other words, the incident light that facilitates the viewing of the holographic images 46 interacts with the colorant layer 42 twice in FIG. 3B.

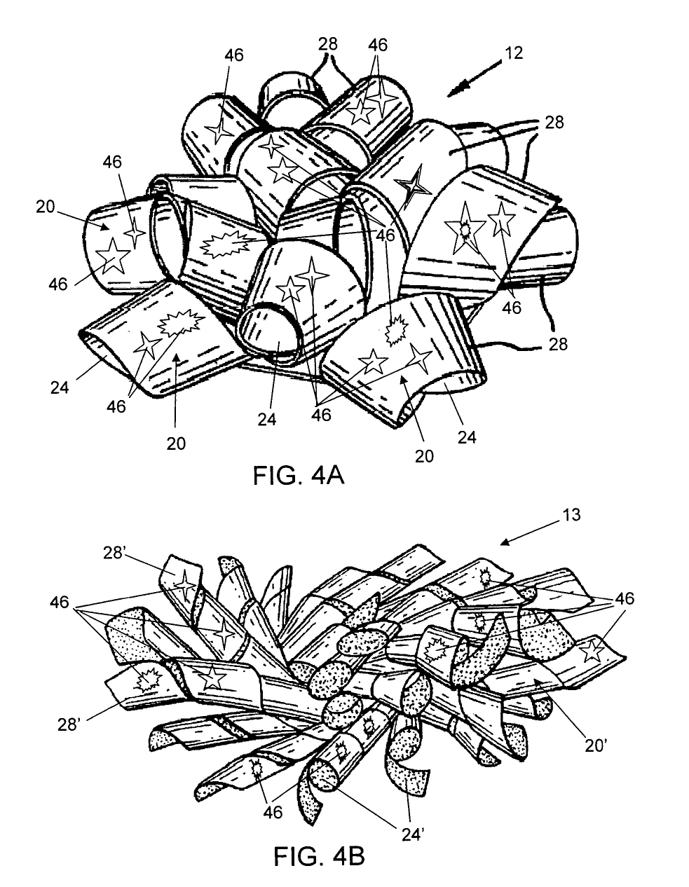

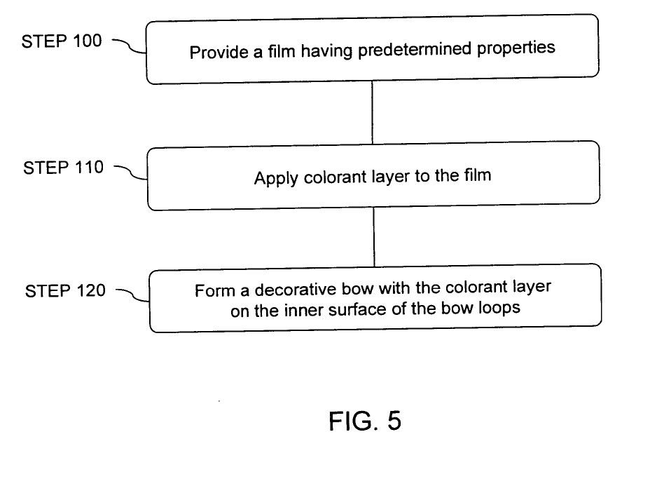

With reference to FIGS. 4A and 5, a bow 12 can be produced by purchasing a commercially available transparent polymeric film, such as, HP-65 from Amagic Holographics, Inc. of California (STEP 100) and applying a colorant to the film (STEP 110). To create the bow 12, the colored film 16 can be slit down to 1.9 cm wide and a Ragen bow machine can be used to form a bow with a plurality of loops 20 (STEP 120). Such a bow 12 can be formed from colored film 16 printed with transparent ink, metallic ink or an opaque coating. When forming the bow 12, it is preferred to form the bow loops 20 with the colorant layer 42 of the film 16 on the inner surface 24 of the loops 20. Thus, the color shown on the outer surface 28 of the bow 12 is modified by the reflection of the colorant layer 42 printed on the high refractive index layer 38. The end result is that the bow 12 appears aesthetically pleasing to the eye. Not only does the outer surface 28 of the bow loop 20 show vivid color and holographic images 46 at different viewing angles, but the inner surface 24 of the bow loops 20 shows an especially strong reflection of the color of the colorant layer 42. This makes the overall appearance of the bow colorful and lively, as illustrated in the examples below.

With reference to FIG. 4B, in another embodiment the film 16 is used to create a decorative ribbon 13 having a plurality of loops 20′ (i.e., curls). Each of the loops 20′ has an inner surface 24′ and an outer surface 28′. Similar to the bow 12, the ribbon is formed with the colorant layer 42 of the film 16 as the inner surface 24′ of the loops 20′. Relatively short lengths of the curled ribbon 13 can be formed into a bow, as shown in FIG. 4B. A decorative element can also be formed from longer lengths of the curled ribbon 13 by affixing the lengths of ribbon at a common point, from which the curled ribbon radiates and hangs downwardly. A decorative element can also be formed from a single length of the curled ribbon 13. The film 16 can be curled and/or packaged in accordance with the methods described in U.S. Pat. No. 6,074,592, U.S. Pat. No. 6,283,907 and U.S. Pat. No. 6,298,639, all of which are incorporated herein by reference. When using the methods described therein, it is important that the film 16 be fed to the curling apparatus such that the colorant layer 42 forms the inner surface 24′ of the loops 20′.

### EXAMPLES

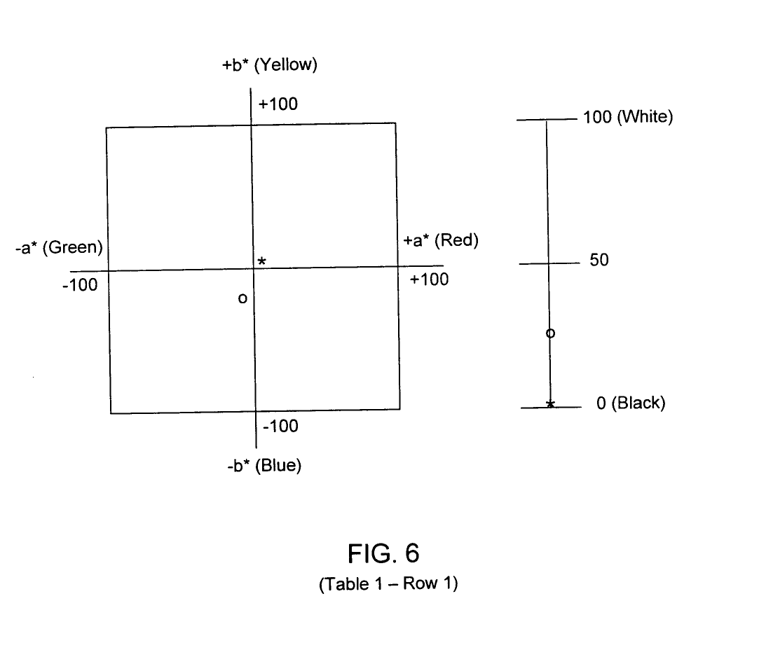

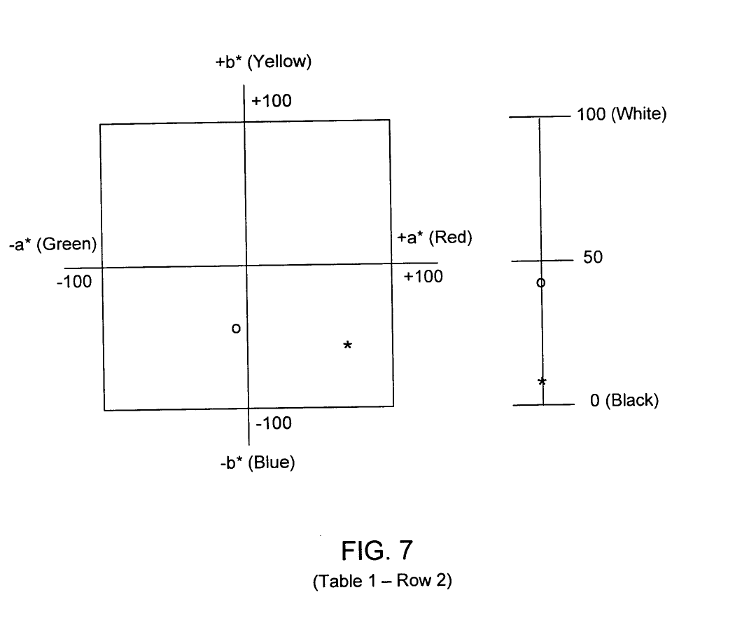

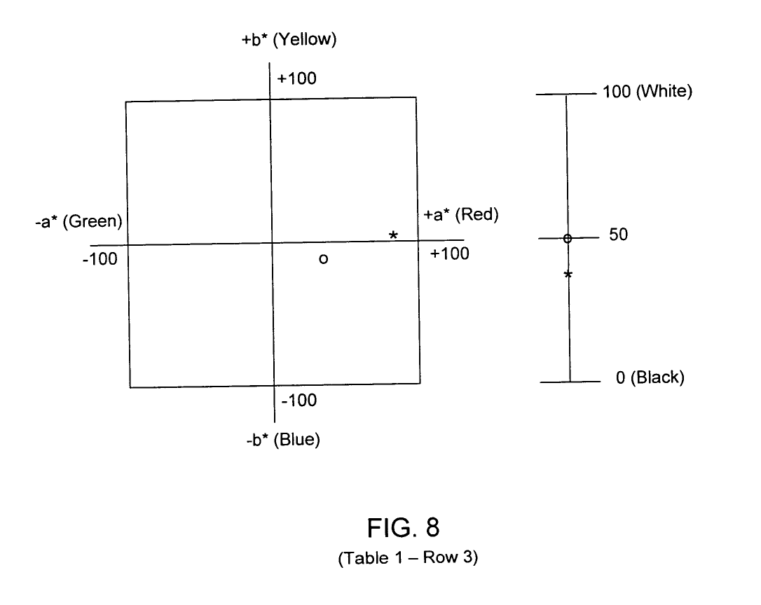

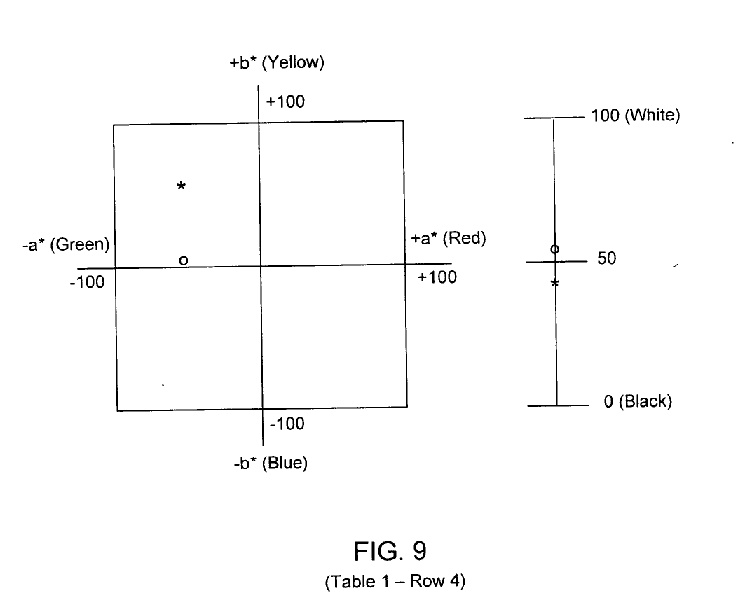

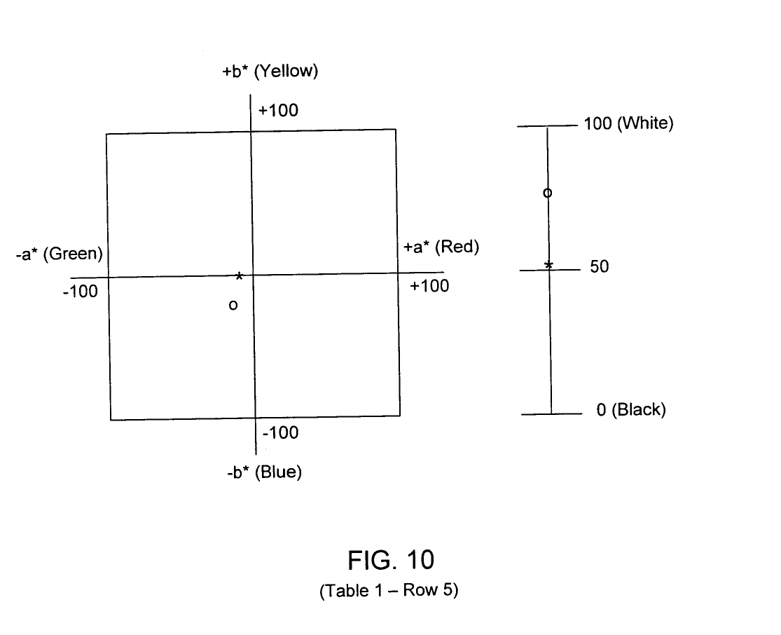

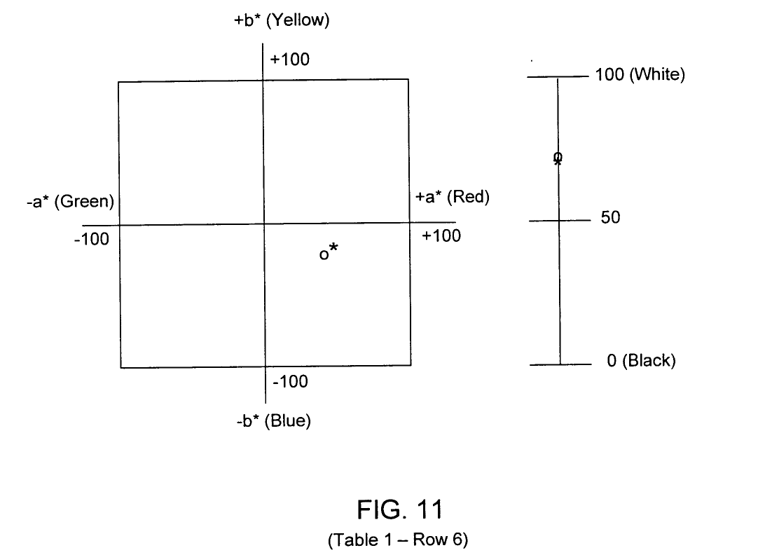

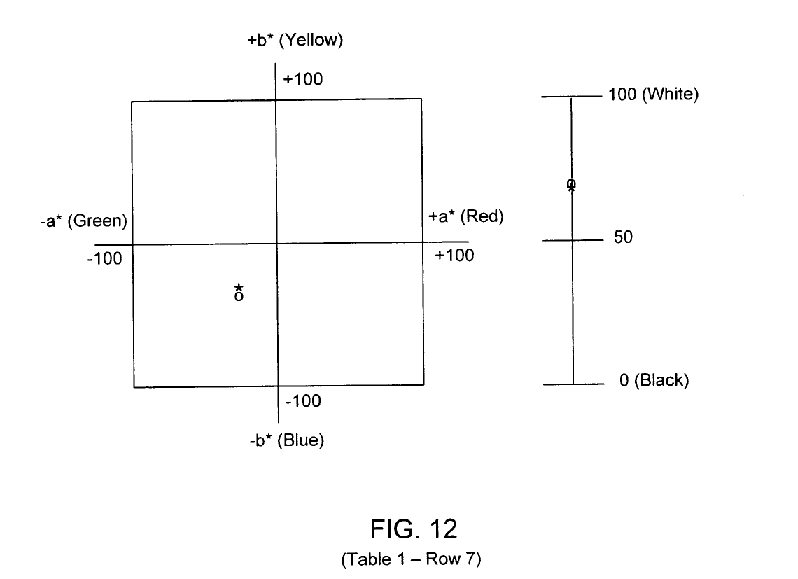

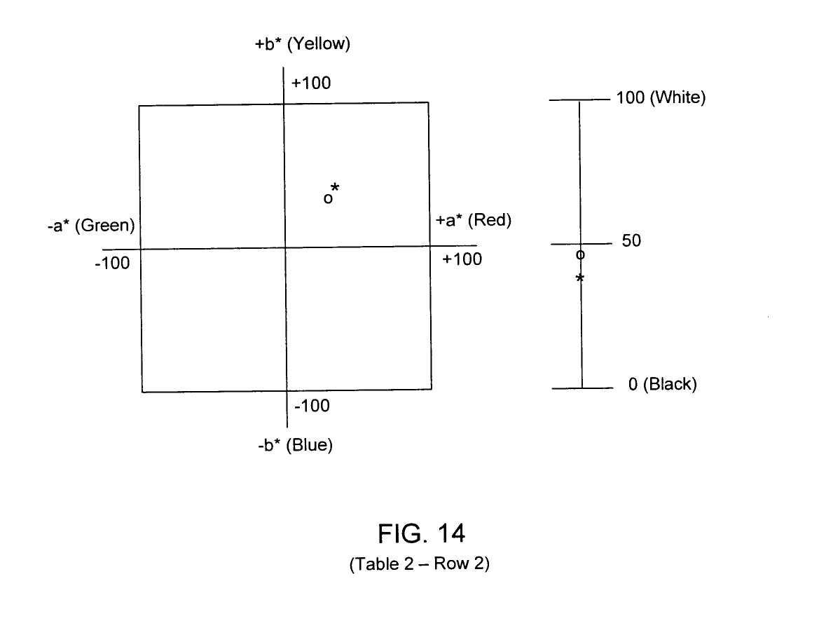

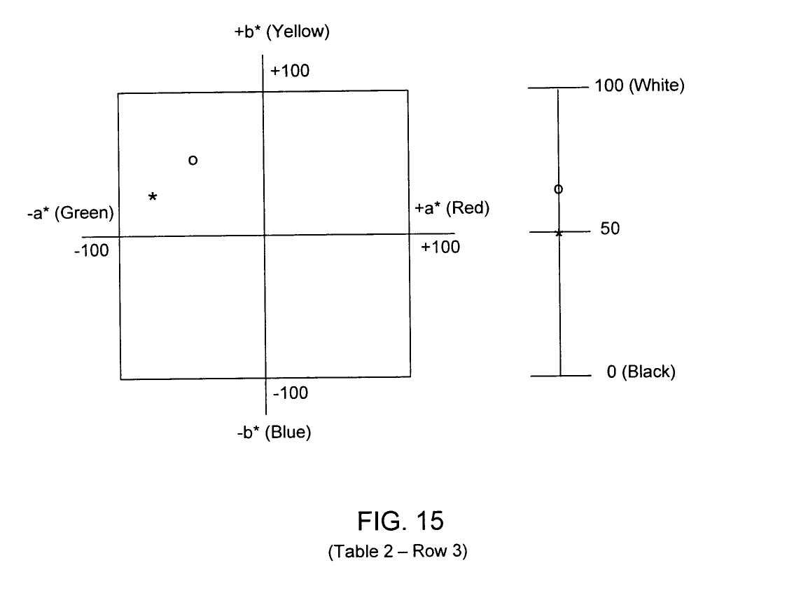

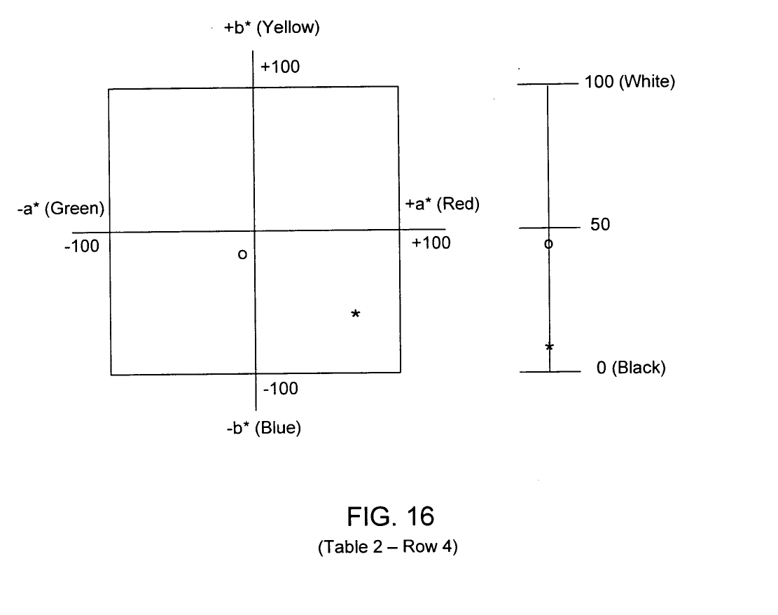

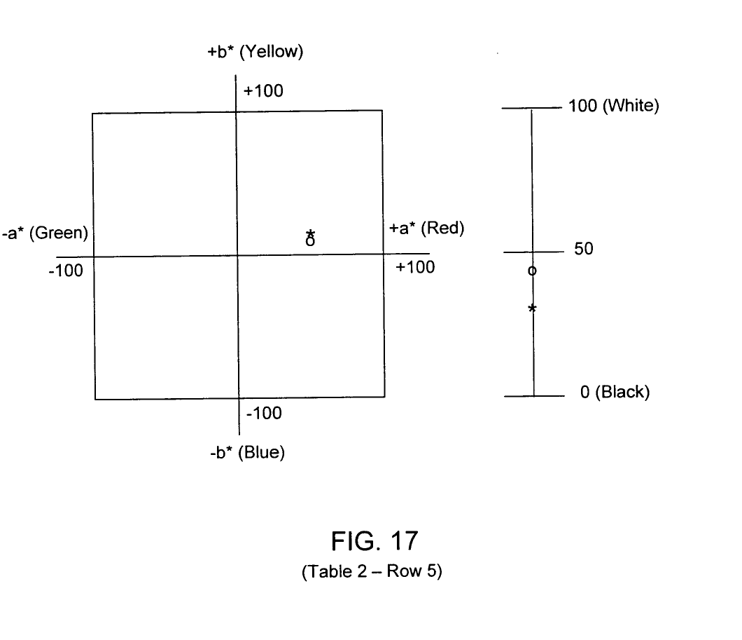

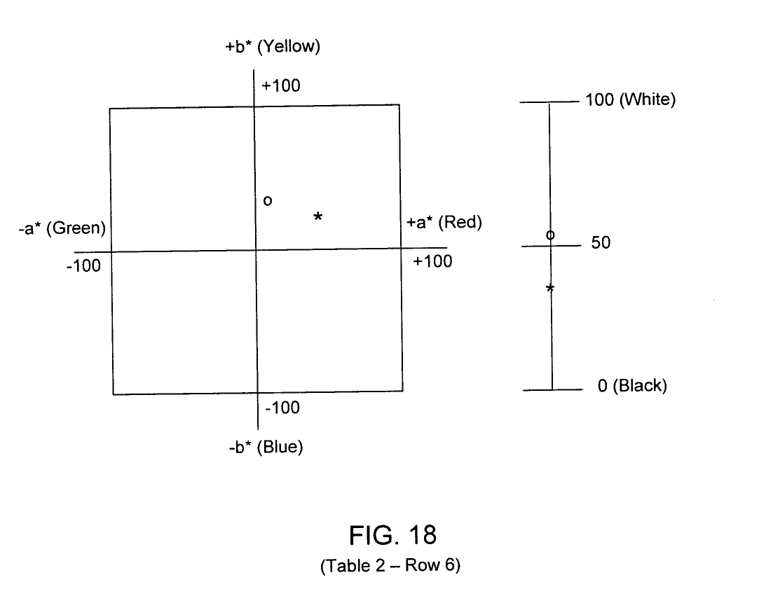

By selecting an appropriate colorant in accordance with the guidelines set forth above, the color qualities of the film can be greatly enhanced. The color can be quantified using the Commission International d'Eclaiage (“CIE”) color scale, which is shown in FIGS. 6-18. In the CIE color scale, the values L*, a* and b* collectively describe the color characteristics of an object. On the right hand side of the CIE, the value of L* represents the lightness of color, 0 representing black color, 100 representing white color, and a range from 0 to 100 representing various degrees of gray color. On the horizontal axis of the left portion of the CIE, a positive a* value represents red color, while a negative a* value represents green color. On the vertical axis, positive b* values represent yellow color, and negative b* values represent blue color. The absolute value of the number represents the strength of the color.

One side of Amagic HP-65 film, embossed with a bubble pattern, was printed with Flink ink 1015 with an anilox roller of 300 lines per 2.54 cm at a web speed of 70 meters per minute by using a Roto Press machine, Model No. 2002, manufactured by Roto Press Engineering Co., Inc., Ohio. The color of the printed film was measured with a Spectro Eye™ Spectro Photometer, manufactured by Gretag Macbeth™, Switzerland. The results of the color analysis of the printed and unprinted sides of the film are shown in FIGS. 6-12 using the CIE color scale. The CIE values of the printed side of the film are plotted with the symbol “*”. For comparison, the symbol “o” represents the unprinted side of the film. Table 1 lists the actual values represented in FIGS. 6-12 for several different colored inks.

TABLE 1
THE CIE COLOR SCALE OF PRINTED HP-65 (BUBBLES)

| | CIE COLOR SCALE | | | | | |
|---|---|---|---|---|---|---|
| | Printed side | | | Non-printed side | | |
| (INK) | L* | a* | b* | L* | a* | b* |
| Transparent black | 2.02 | 1.09 | 1.64 | 25.38 | −4.14 | −37.15 |
| ink | | | | | | |
| Transparent violet | 10.61 | 66.55 | −64.61 | 38.80 | −4.76 | −47.56 |
| ink | | | | | | |
| Transparent red ink | 37.14 | 75.57 | 2.65 | 50.12 | 41.50 | −17.87 |
| Metallic green ink | 42.07 | −36.96 | 36.52 | 54.86 | −34.18 | 3.72 |
| Metallic light purple | 51.12 | −2.89 | −0.68 | 66.22 | −13.59 | −15.77 |
| ink | | | | | | |
| Opaque pink ink | 66.21 | 46.59 | −9.16 | 67.47 | 35.05 | −15.59 |
| Opaque light blue | 63.13 | −29.02 | −39.62 | 65.37 | −29.68 | −43.39 |
| ink | | | | | | |

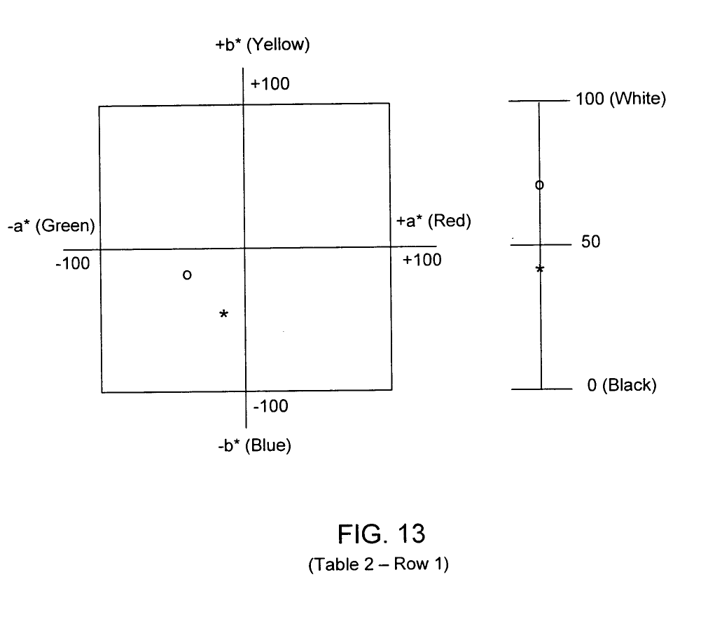

FIGS. 13-18 show the CIE color scale of the printed sides of KP-14 film, by Amagic Holographics, Inc., embossed with a geosquares pattern as compared to the unprinted side. The CIE values of the printed side of the film are plotted with the symbol “*”. For comparison, the symbol “o” represents the unprinted side of the film. Table 2 lists the actual values represented in FIGS. 13-18 for several different colors of ink.

TABLE 2
THE CIE COLOR SCALE OF PRINTED KP-14 (GEOSQUARES)

| | CIE COLOR SCALE | | | | | |
|---|---|---|---|---|---|---|
| | Printed side | | | Non-printed side | | |
| (INK⁺) | L* | a* | b* | L* | a* | b* |
| Transparent royal | 43.24 | −9.19 | −56.38 | 65.37 | −18.03 | −20.51 |
| blue ink | | | | | | |
| Transparent copper | 34.78 | 39.97 | 41.91 | 48.49 | 34.92 | 30.32 |
| ink | | | | | | |
| Transparent emerald | 50.95 | −76.26 | 29.27 | 63.17 | −54.66 | 40.00 |
| ink | | | | | | |
| Transparent violet | 12.48 | 70.43 | −68.70 | 44.76 | −4.53 | −18.01 |
| ink | | | | | | |
| Metallic dark red | 25.60 | 50.65 | 16.40 | 35.10 | 50.42 | 11.21 |
| ink | | | | | | |
| Metallic light red | 32.15 | 44.92 | 24.06 | 55.96 | 14.27 | 37.51 |
| ink | | | | | | |

⁺The transparent royal blue ink and the transparent copper ink were manufactured by Ameritech Ink. The remaining inks were manufactured by Flink Ink Corporation.

As noted above, a variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A decorative element comprising:
a film formed into a plurality of loops having an inner surface and an outer surface, the film comprising:
a transparent polymeric layer;
a coating layer disposed on a first surface of the polymeric layer;
a plurality of embossed images disposed within the coating layer;
a high refractive index layer substantially covering the embossed images; and
a colorant layer disposed on a second surface of the polymeric layer or the high refractive index layer, the colorant layer forming the inner surface of the loops.

2. The decorative element of claim 1 wherein the embossed images are micro-embossed.

3. The decorative element of claim 1 wherein the transparent polymeric layer is selected from the group consisting of polyester, biaxially-oriented polypropylene, and polyvinyl chloride.

4. The decorative element of claim 1 wherein in the colorant layer comprises an ink.

5. The decorative element of claim 4 wherein the ink is selected from the group consisting of a transparent ink, an opaque ink, and a metallic ink.

6. The decorative element of claim 1 wherein the high refractive index layer has a refractive index greater than 2.4 at a wavelength of approximately 10.6 μm.

7. The decorative element of claim 1 wherein the high refractive index layer comprises zinc sulfide.

8. A method of making a decorative element comprising the steps of:
providing a film having a transparent polymeric layer, a coating layer disposed on a first surface of the transparent layer, a plurality of embossed images within the coating layer, and a high refractive index layer substantially covering the embossed images;
applying a colorant to a second surface of the polymeric layer or the high refractive index layer; and
forming a plurality of loops of the film having an inner surface and an outer surface, the inner surface being the colorant layer of the film.

9. The method of claim 8 wherein the applying step comprises applying an ink to the film.

10. The method of claim 9, wherein the ink is selected from the group consisting of a transparent ink, an opaque ink, and a metallic ink.

11. A decorative bow of the type having a plurality of bow loops joined at a central point, the bow comprising:
a polymeric film comprising a clear polyester layer, a micro-embossed coating disposed on a first surface of the polyester layer, a high refractive index layer disposed on the micro-embossed coating, and a continuous, substantially uniform ink layer printed on the high refractive index layer or on a second surface of the polymeric layer;
wherein the bow loops are formed with the continuous ink layer disposed on an inside surface of the bow loops.

12. The bow of claim 11 wherein the high refractive index layer comprises zinc sulfide.

13. A decorative element having at least one length of ribbon curled into loops, the decorative element comprising:
a polymeric film comprising a clear polyester layer, a micro-embossed coating disposed on a first surface of the polyester layer, a high refractive index layer disposed on the micro-embossed coating, and a continuous, substantially uniform ink layer printed on the high refractive index layer or a second surface of the polymeric layer;
wherein the loops are formed with the continuous ink layer disposed on an inside surface of the loops.

14. The decorative element of claim 13 wherein the high refractive index layer comprises zinc sulfide.

15. The decorative element of claim 13 comprising a plurality of lengths of curled ribbon radiating from a common point.
